(19) United States
(12) Patent Application Publication
(10) Pub. No.: US 2024/0071244 A1
(43) Pub. Date: Feb. 29, 2024

(54) RECIPROCAL COMMUNICATION TRAINING SYSTEM

(71) Applicant: Bumblebee Communications, LLC, Edgewater, CO (US)

(72) Inventor: Karma L. Ansbacher, Edgewater, CO (US)

(73) Assignee: Bumblebee Communications, LLC, Edgewater, CO (US)

(21) Appl. No.: 17/823,359

(22) Filed: Aug. 30, 2022

(51) Int. Cl. G09B 5/06; G06F 3/04817; G06F 3/0482; G06F 3/0484; G06F 3/04886; G06F 3/16; G09B 19/00

(52) U.S. Cl. CPC G09B 5/06; G06F 3/04817; G06F 3/0482; G06F 3/0484; G06F 3/04886; G06F 3/165; G09B 19/00

(57) ABSTRACT

A system to facilitate reciprocal communication between a first user and a second user is described. The system includes a processor configured to display primary graphics on a user interface. The first user may select a first graphic from the plurality of primary graphics and display graphics on the user interface based on first graphic selection. The first user may further select a second graphic from the plurality of secondary graphics. The processor may further model a sentence based on the first and second graphic selection. The processor may obtain a sentence submission from the first user and transmit a first audio output. The processor may additionally display a second menu on the user interface in order that the second user may respond to the first user. The processor may transmit a second audio output based on their selection and the first user may respond or initiate a new conversation.

### TECHNICAL FIELD

The present disclosure relates to a system and method to facilitate reciprocal communication between users, and more particularly, to facilitate reciprocal communication between a parent and a child by using verbal cues for child development.

### BACKGROUND

Children start to build vocabulary and learn to frame sentences during the early stages of childhood. Parents and teachers spend considerable time and effort to teach words and phrases to children during the children's formative years. Children with special needs, such as those with low-functioning autism, often require more time to learn new words, frame sentences and communicate with others, as compared to other children. The path to meaningful communication between parents and autistic children may be challenging and require patience on the part of both child and parent.

Parents with autistic children use a number of conventional vocabulary-building tools that teach words and sentences to their children, and to encourage communication so that the children can express their needs and desires. Examples of conventional vocabulary building tools include posters or placards with colorful images and words, audio or video children rhymes, educational games/toys, and the like. While the conventional vocabulary building tools may provide some relief during the early stages of communication training, they are unable to hold a child's attention for a longer time duration. For example, a word poster is usually static and the child's attention may waver quickly when a parent uses such a poster to teach words.

In addition, the conventional vocabulary building tools typically enable one-way communication, e.g., from the parent to the child, and may not assist the child to communicate with the parent. In the absence of child's communication with the parent, the child's learning curve may be difficult.

Thus, there is a need for a dynamic system and method that can enable reciprocal communication between the parent and the child. It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a block diagram of an example reciprocal communication system in accordance with the present disclosure.

FIG. 3A depicts an example snapshot of the reciprocal communication system illustrating a plurality of primary graphics in accordance with the present disclosure.

FIG. 3B depicts an example snapshot of the reciprocal communication system illustrating a plurality of secondary graphics in accordance with the present disclosure.

FIG. 4 depicts an example snapshot of the reciprocal communication system illustrating a modeled sentence in accordance with the present disclosure.

FIG. 5 depicts an example snapshot of the reciprocal communication system illustrating a transition screen in accordance with the present disclosure.

FIG. 6 depicts an example snapshot of the reciprocal communication system illustrating a parent input screen in accordance with the present disclosure.

FIG. 7 depicts a flow diagram of an example reciprocal communication method in accordance with the present disclosure.

FIG. 8 depicts a flow diagram of an example reward display method in accordance with the present disclosure.

### DETAILED DESCRIPTION

### Overview

The present disclosure describes a system to facilitate reciprocal communication between a parent and a child. The child may be learning vocabulary and sentence formation, and the parent may use the system to encourage the child to have reciprocal communication with the parent. The system may further be used to teach vocabulary and sentence formation to children with special needs such as, for example, autistic children. In some aspects, the system may display a plurality graphics (e.g., colorful images, icons, text, etc.) on a system user interface, and the child may click on one or more graphics. The graphics may correspond to words or verbal cues that the first user may want to communicate to the parent. For example, the graphics may be icons with text “Mom”, “I want”, “Breakfast”, “Play”, “Hug”, “Food”, “Drink”, and the like. The system may output audio signals when the child clicks on the graphics. Further, the system may model a sentence based on the one or more graphics that the child clicks. For example, the system may model a sentence “Mom I want Breakfast”, when the child clicks the corresponding graphics. The child may submit the sentence on the system, when the child finishes forming the sentence. The system may output an audio signal corresponding to the sentence, and may then prompt the parent to respond to the child's sentence. The parent may respond to the child on the system, and then the system may prompt the child to respond back. In this manner, the system encourages the child to have reciprocal communication with the parent.

In some aspects, the system may further enable the parent to set communication goals for the child on the system and assign rewards that may be provided to the child when the child achieves the goals. For example, the parent may set a communication goal such that the child may get a treat when the child submits more than three sentences in a reciprocal communication session. The system may display the goals and the rewards on the system user interface, which may encourage the child to form a higher number of sentences in the reciprocal communication session. In addition, the system may track the number of sentences that the child forms, and display the reward won by the child, when the child or the parent end the communication session.

In some aspects, the parent may customize the graphics that may be displayed on the system user interface. For example, the parent may add images of people known to the child, colorful icons, etc., which may make the graphics appealing to the child.

The present disclosure discloses a reciprocal communication system that enables the parent and the child to engage in reciprocal communication by using customizable icons, images, audio signals, and customizable positive feedback. The customizable icons, images, and audio signals may assist in retaining child's attention to the system for a longer time duration. In this manner, the child may engage in lengthier reciprocal communication with the parent, and may thus help in child development. Further, the parent may set communication goals on the system that may act as positive reinforcement for the child to prepare a higher number of sentences on the system. This may further help in faster and robust child development.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

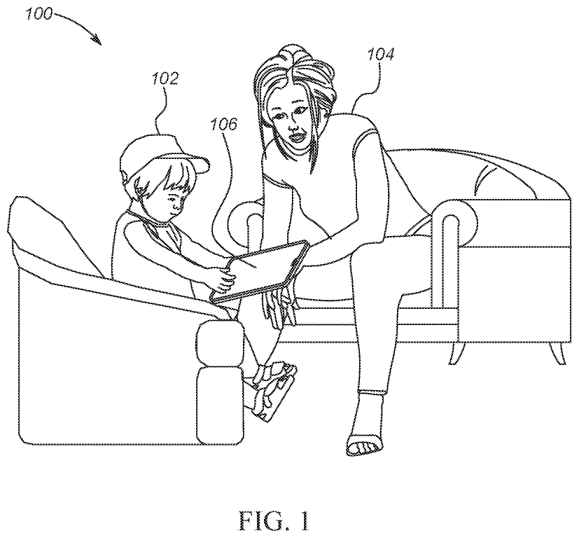

FIG. 1 depicts an example environment 100 in which techniques and structures for providing the systems and methods disclosed herein may be implemented. The environment 100 may include a first user 102, a second user 104, and a reciprocal communication system 106. The first user 102 may be a child and the second user 104 may be a parent (e.g., mother) or a teacher. In some aspects, the first user 102 may be a special child (e.g., an autistic child) and the second user 104 may be training/teaching vocabulary or sentence formation to the first user 102 to encourage communication so that the first user 102 may express his needs or desires. For example, the first user 102 may be a child with less than five years of age and may not speak or speak limited words and sentences. The second user 104 may use the reciprocal communication system 106 to encourage communication and provide vocabulary training to the first user 102.

In some aspects, the reciprocal communication system 106 may facilitate in child development. Specifically, the reciprocal communication system 106 may facilitate and encourage reciprocal communication between the first user 102 and the second user 104. For example, the reciprocal communication system 106 may facilitate the first user 102 to ask questions to the second user 104, respond to second user questions, engage in iterative conversation, etc., which may assist the first user 102 to develop communication skills.

In some aspects, the reciprocal communication may help in faster learning of words and sentences, and hence may help in overall robust child development. For example, the reciprocal communication system 106 may display a plurality of selectable graphics on a system user interface (not shown), and the first and the second users 102, 104 may take turns selecting the graphics. The plurality of selectable graphics may correspond to words, phrases, or verbal cues that the first user 102 may want to communicate to the second user 104. The reciprocal communication system 106 may enable the first user 102 to form sentences by using the plurality of selectable graphics. The plurality of selectable graphics may also include responses (in the form of text, images, or icons) that the second user 104 may select, in response to a first user selection of one or more graphics, to engage in reciprocal communication with the first user 102.

In some aspects, the reciprocal communication system 106 may output audible signals corresponding to the selected graphics when the first user 102 and/or the second user 104 select the graphics. The audible signals and the graphics on the system user interface may assist in retaining the first user's attention for a longer duration of time (as compared to the conventional vocabulary building tools) and may enable faster first user learning.

In some aspects, the reciprocal communication system 106 may be configured on a user device, for example, a laptop, a mobile phone, a tablet, and the like. In other aspects, the reciprocal communication system 106 may be a standalone system to facilitate reciprocal communication between the first user 102 and the second user 104.

The reciprocal communication system 106 may be further configured to enable the second user 104 to set communication goals for the first user 102 and may assign rewards that may be provided to the first user 102 when the first user 102 achieves one or more communication goals. For example, the second user 104 may set a communication goal such that the first user 102 may get a treat when the first user 102 forms three sentences in a reciprocal communication session with the second user 104. Similarly, the second user 104 may set another communication goal such that the first user 102 may get to play an online game on the second user device when the first user 102 forms more than five sentences in the reciprocal communication session.

In some aspects, the second user 104 may set the communication goals on the reciprocal communication system 106, and the system user interface may display the goals (in the form of graphics or images), so that the goals act as a positive reinforcement for the first user 102 to form higher number of sentences. In this manner, the reciprocal communication system 106 may encourage the first user 102 to engage in lengthier reciprocal communication with the second user 104 and may thus help in faster child development.

In further aspects, the reciprocal communication system 106 may be connected to a server (not shown) that may receive information of a first user interaction with the reciprocal communication system 106. The information may include, for example, several sentences formed by the first user 102, an average number of words in each sentence, time spent in the reciprocal communication session, and/or the like. Responsive to receiving the information, the server may transmit the information to a medical resource associated with the first user 102. In one or more aspects, the medical resource may be a doctor and may track a first user progress (in terms of communication skills, child development, etc.).

The reciprocal communication system 106 may be further configured to receive reward recommendations from the server based on the information associated with the first user interaction with the reciprocal communication system 106. For example, the reciprocal communication system 106 may receive recommendations from the server to modify rewards that may be displayed on the system user interface for the first user 102, to further encourage the first user 102 to engage in lengthier reciprocal communication with the second user 104. In some aspects, the reciprocal communication system 106 may display the recommendations to the second user 104, who may modify the rewards based on the recommendations.

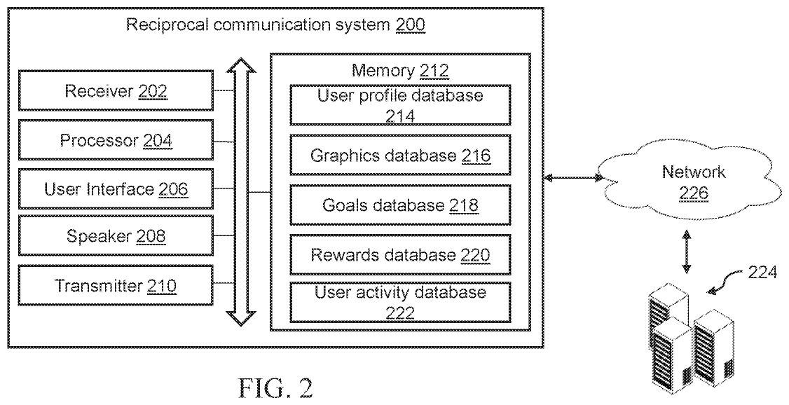

The server may provide the reward recommendations based on inputs received from the medical resource and/or a neural network model that may be executed on the server. The details associated with the reciprocal communication system 106 and the server are described in conjunction with FIG. 2.

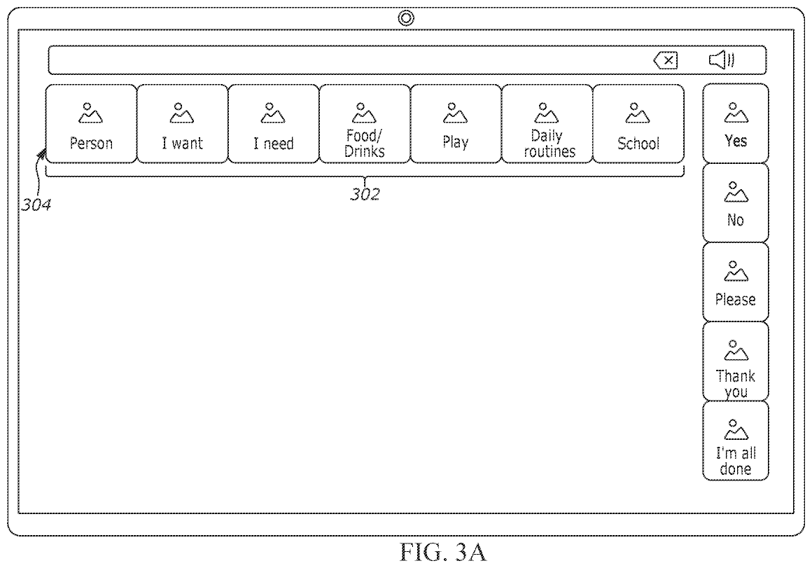

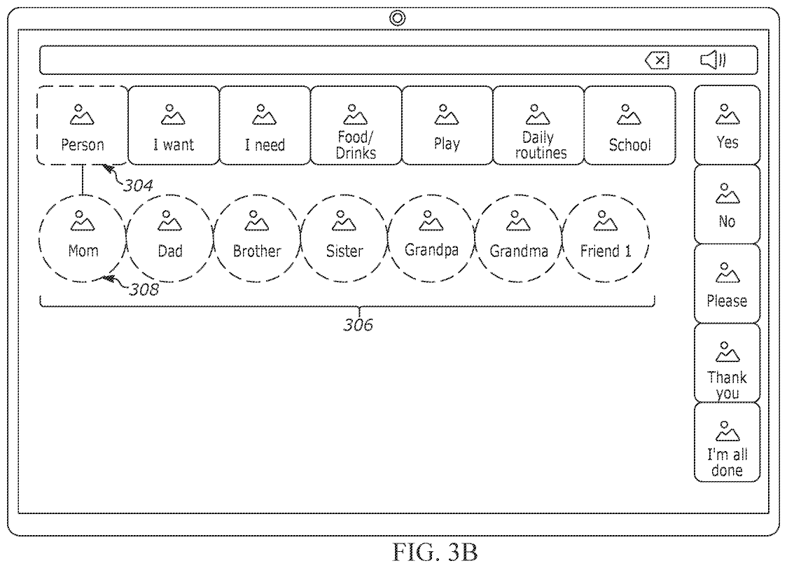

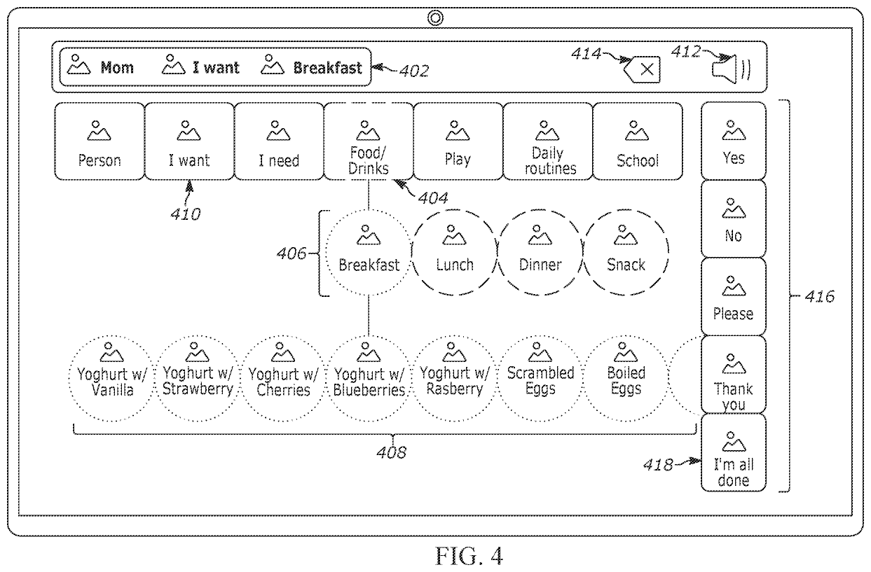

FIG. 2 depicts a block diagram of an example reciprocal communication system 200 in accordance with the present disclosure. The reciprocal communication system 200 may be same as the reciprocal communication system 106. In some aspects, the reciprocal communication system 200, as described herein, can be implemented in hardware, software (e.g., firmware), or a combination thereof. While describing FIG. 2, references would be made to FIG. 3A, FIG. 3B, and FIGS. 4-6.

The reciprocal communication system 200 may include a plurality of units including, but not limited to, a receiver 202, a processor 204, a user interface 206, a speaker 208, a transmitter 210, and a memory 212. The plurality of units may communicatively couple with each other via a bus.

In some aspects, the memory 212 may store programs in code and/or store data for performing various reciprocal communication system operations in accordance with the present disclosure. Specifically, the processor 204 may be configured and/or programmed to execute computer-executable instructions stored in the memory 212 for performing various reciprocal communication system functions in accordance with the disclosure. Consequently, the memory 212 may be used for storing code and/or data code and/or data for performing operations in accordance with the present disclosure.

In one or more aspects, the processor 204 may be disposed in communication with one or more memory devices (e.g., the memory 212 and/or one or more external databases (not shown in FIG. 2)). The memory 212 can include any one or a combination of volatile memory elements (e.g., dynamic random-access memory (DRAM), synchronous dynamic random-access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc.).

The memory 212 may be one example of a non-transitory computer-readable medium and may be used to store programs in code and/or to store data for performing various operations in accordance with the disclosure. The instructions in the memory 212 can include one or more separate programs, each of which can include an ordered listing of computer-executable instructions for implementing logical functions.

In further aspects, the memory 212 may include a plurality of databases including, but not limited to, a user profile database 214, a graphics database 216, a goals database 218, a rewards database 220, and a user activity database 222. The processor 204 may be configured to access the plurality of databases to perform reciprocal communication system operations in accordance with the present disclosure.

In operation, a child (e.g., the first user 102) and a parent (e.g., the second user 104) may access the reciprocal communication system 200 to perform reciprocal communication with each other, as described above. Specifically, to access the reciprocal communication system 200, the second user 104 may create a user profile on the reciprocal communication system 200 when the second user 104 accesses the reciprocal communication system 200 for the first time. For example, the second user 104 may send parent information and child information to the receiver 202, which may then send the information to the user profile database 214 for storage purpose. The parent information may include, for example, parent name, login credentials (if applicable), parent preferences for rewards for the child, parent preferences for display on the user interface 206, parent image, parent gender, and/or the like. The child information may include child age, gender, child routine activities, child's preferences, and/or the like. The second user 104 may access the reciprocal communication system 200 when the user profile is created.

To access the reciprocal communication system 200, the first user 102 or the second user 104 may send an access request to the receiver 202. In some aspects, the first user 102 may access the reciprocal communication system 200 to express his desire or need and/or to communicate with the second user 104. Similarly, the second user 104 may access the reciprocal communication system 200 when the second user 104 wants to initiate a reciprocal communication session with the first user 102. In some aspects, the first user 102 or the second user 104 may send the access request to the receiver 202 by submitting (e.g., clicking) a dedicated access button or a “Start” button on the user interface 206.

Responsive to receiving the access request, the receiver 202 may send the access request to the processor 204. The processor 204 may in turn request, via the user interface 206, the first user 102 or the second user 104 to provide login credentials to grant access to the first user 102 or the second user 104. In some aspects, the processor 204 may grant access to the first user 102 or the second user 104 without requesting for login credentials, if the first user 102 or the second user 104 does not have an associated login credential.

In one or more aspects, the processor 204 may fetch a first menu of a plurality of primary graphics from the graphics database 216, when the processor 204 grants access for the reciprocal communication system 200. The plurality of primary graphics may be selectable graphics that may be associated with a plurality of verbal cues. In some aspects, the graphics database 216 may pre-store the plurality of primary graphics. In further aspects, the plurality of primary graphics may be customized based on the user profile.

Responsive to fetching the first menu, the processor 204 may display the first menu on the user interface 206. An example of a first menu including the plurality of primary graphics that is displayed on the user interface 206 is shown in FIG. 3A. Specifically, FIG. 3A depicts an example snapshot of the reciprocal communication system 200 illustrating a plurality of primary graphics 302 that may be displayed on the user interface 206.

As shown in FIG. 3A, the plurality of primary graphics 302 may correspond to a plurality of categories (e.g., parent or primary taxonomy categories), such as “People”, “I want”, “I need”, “I feel”, food, drinks, daily routine, play, comfort, help, descriptors, school, and the like. In some aspects, the second user 104 (or the first user 102) may customize the plurality of primary graphics 302 by adding/uploading images, colors, custom graphics, etc., to make the plurality of primary graphics 302 appealing to the first user 102. The customized primary graphics may be stored in the graphics database 216, and the processor 204 may fetch the customized primary graphics when the second user 104 accesses the reciprocal communication system 200.

In response to the primary graphics' display on the user interface 206, the first user 102 may select a primary graphic to begin conversation with the second user 104. Specifically, the first user 102 may click on a primary graphic icon, e.g., a people icon 304, to begin the conversation. Responsive to the first user 102 clicking the people icon 304, the processor 204 may receive a signal from the user interface 206 indicating that the first user 102 has clicked the people icon 304. The processor 204 may then send the signal to the user activity database 222 to store a first user activity. In addition, responsive to receiving the signal, the processor 204 may fetch a plurality of secondary graphics associated with the selected primary graphic (e.g., the people icon 304) from the graphics database 216.

In some aspects, the plurality of secondary graphics may be associated with child taxonomy categories of a parent taxonomy category of the selected primary graphic. Specifically, one or more primary graphics, from the plurality of primary graphics 302, may be associated with parent taxonomy categories, and one or more primary graphics may have associated child taxonomy categories. For example, the “people” category (corresponding to the people icon 304) may have associated secondary categories as “Mom”, “Dad”, “Brother”, “Sister”, “Grandpa”, “Grandma”, “Friend”, and the like. Similarly, the “daily routines” category may have associated second categories as “dressing”, “bathing”, “play”, “mealtimes”, “outings”, and the like. Likewise, the “comfort” category may have associated secondary categories as “hug”, “kiss”, “cuddle”, “swinging”, “chewy toy”, “comfort place”, “weighted blanket”, and the like.

In some aspects, the graphics database 216 may store a mapping of the primary taxonomy categories of the one or more primary graphics with the associated secondary taxonomy categories.

Responsive to fetching the plurality of secondary graphics associated with the selected primary graphic (e.g., the people icon 304) from the graphics database 216, the processor 204 may display the secondary graphics on the user interface 206. An example of secondary graphics is shown in FIG. 3B. Specifically, FIG. 3B depicts an example snapshot of the reciprocal communication system 200 illustrating a plurality of secondary graphics 306 that may be displayed on the user interface 206 when the first user 102 clicks on the people icon 304.

In some aspects, like the plurality of primary graphics 302, the second user 104 may customize the plurality of secondary graphics 306 to retain the first user's attention on the reciprocal communication system 200 for a longer time duration and to encourage communication. For example, the first user 102 or the second user 104 may customize the plurality of secondary graphics 306 by adding people images, e.g., mom, dad, grandpa, grandma, and the like, to the secondary icons/graphics. This may help the first user 102 to quickly identify the person on the displayed icon/graphic.

The first user 102 may click on a secondary graphic, e.g., a mom icon 308, when the processor 204 displays the plurality of secondary graphics 306 on the user interface 206. Responsive to the first user 102 clicking the mom icon 308, the user interface 206 may send a signal to the processor 204 indicating that the first user 102 has clicked on the mom icon 308. The processor 204 may then send or cause transmission of a signal to the speaker 208 to output an audio corresponding to the mom icon 308. For example, the speaker 208 may output “Mom” when the first user 102 clicks on the mom icon 308.

In some aspects, the graphics database 216 may store an audio/audible signal corresponding to each graphic (e.g., the plurality of primary graphics 302 and the plurality of secondary graphics 306), and the processor 204 may fetch the audio/audible signal associated with the mom icon 308 from the graphics database 216 to cause the speaker 208 to output “Mom”.

In one or more aspects, the speaker 208 may output the audio when the first user 102 clicks on one or more primary and/or secondary graphics, and not for all the plurality of primary graphics 302 and the plurality of secondary graphics 306. Specifically, the second user 104 may customize reciprocal communication system speaker settings to enable audio for the one or more primary and/or secondary graphics and disable the audio for the remaining graphics.

For example, the second user 104 may customize the speaker settings such that the speaker 208 outputs the audio when the first user 102 clicks on the mom icon 308 and may not output any audio/audible signal when the first user 102 click on the people icon 304. In other aspects, the second user 104 may customize the speaker settings such that the speaker 208 may output audio when the first user 102 clicks on any graphic that may be displayed on the user interface 206. In this case, the speaker 208 may output audio for both the mom icon 308 and the people icon 304.

The user profile database 214 may store the reciprocal communication system speaker settings when the second user 104 customizes the settings. In this case, the processor 204 may first fetch the speaker settings from the user profile database 214 when the first user 102 clicks on a graphic on the user interface 206 and may then cause audio signal transmission to the speaker 208, which may output the corresponding audio based on the speaker settings.

In further aspects, the processor 204 may model a sentence on the user interface 206, when the first user 102 clicks on one or more additional primary graphics and respective plurality of secondary graphics 306. A snapshot of a modeled sentence is shown in FIG. 4. Specifically, FIG. 4 depicts an example snapshot of the reciprocal communication system 200 illustrating a modeled sentence 402 that may be displayed on the user interface 206.

The processor 204 may model the sentence 402 based on first user clicks or selections of the plurality of primary graphics 302 and/or the plurality of secondary graphics 306. In additional aspects, as shown in FIG. 4, a plurality of tertiary graphics may be associated with the secondary graphics. Specifically, in the example snapshot depicted in FIG. 4, a primary graphic may be a food/drink icon 404, and corresponding secondary graphics 406 may include “Breakfast”, “Lunch”, “Dinner”, and “Snacks”. A plurality of tertiary graphics 408, corresponding to the “Breakfast” secondary graphic, may include “Yoghurt w/ Vanilla”, “Yoghurt w/ Strawberry”, “Yoghurt w/ cherries”, and the like.

When the first user 102 clicks on one or more primary graphics, for example the mom icon 308 (as shown in FIG. 3B) and an “I want” icon 410, the processor 204 may model a sentence by using “Mom” and “I want”, as shown in the sentence 402. Further, the processor 204 may display the secondary graphics 406 on the user interface 206, when the first user 102 clicks on the food/drinks icon 404. In an example, the first user 102 may click on “Breakfast” icon from the secondary graphics 406, and the processor 204 may then display the plurality of tertiary graphics 408 on the user interface 206. In other words, the processor 204 may sequentially display the secondary graphics 406 and the tertiary graphics 408, when the first user 102 clicks on a primary graphic (e.g., the food/drink icon 404).

In some aspects, the plurality of tertiary graphics 408 may correspond to tertiary taxonomy categories of the secondary taxonomy categories associated with the secondary graphics 406. As already described above, the secondary taxonomy categories may correspond to primary taxonomy categories associated with one or more primary graphics.

In one or more aspects, if the first user 102 clicks on any tertiary graphic, the sentence 402 may indicate the selected tertiary graphic. In a scenario where the first user 102 does not want to click on any tertiary graphic, the first user 102 may click on a submission button 412, to indicate to the processor 204 that the first user 102 has finished forming the sentence. In the example snapshot shown in FIG. 4, the first user 102 may not have clicked on any tertiary graphic, and hence the sentence 402 may include “Mom I want Breakfast.”

In some aspects, the first user 102 may correct or modify the sentence 402 by clicking on a correction button 414. For example, the first user 102 may remove “Breakfast” from the sentence 402 and may modify it with “Snack”. The first user 102 may modify the sentence 402 while the first user 102 forms or finalizes the sentence 402, or before clicking on the submission button 412.

In some aspects, the user interface 206 may send a submission signal to the processor 204 when the first user 102 clicks on the submission button 412. Responsive to receiving the submission signal, the processor 204 may store information associated with the first user activity in the user activity database 222. The information associated with the first user activity may include, for example, number of words included in the sentence 402, a time taken by the first user 102 to form the sentence 402, several corrections made by the first user 102 while forming the sentence 402, and/or the like.

In addition, the processor 204 may cause the speaker 208 to output an audio corresponding to the sentence 402, when the first user 102 clicks on the submission button 412. Specifically, the processor 204 may cause transmission of an audio signal to the speaker 208, which may output the audio corresponding to the sentence 402 based on the audio signal.

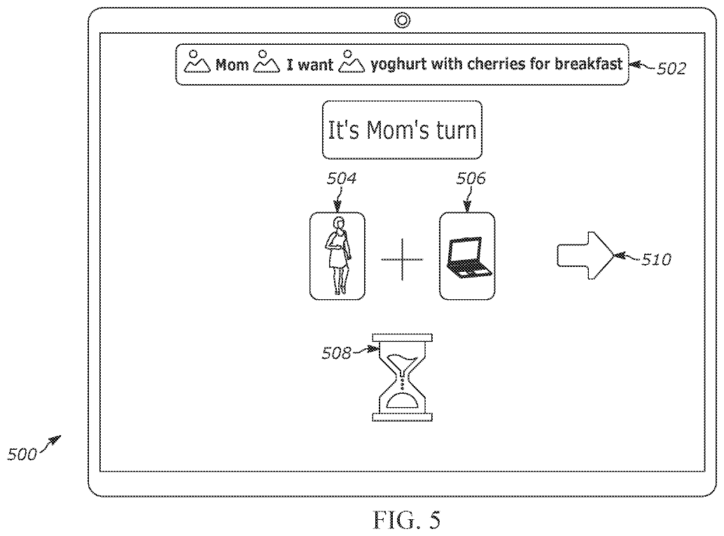

In further aspects, the processor 204 may cause the user interface 206 to display a transition screen when the first user 102 clicks on the submission button 412. The transition screen may indicate to the second user 104 that the first user 102 has finished forming the sentence, and the second user 104 may input a response. FIG. 5 depicts an example snapshot of the reciprocal communication system 200 illustrating a transition screen 500 that may be displayed on the user interface 206, when the first user 102 clicks on the submission button 412.

The transition screen 500 may display a sentence 502 (that the first user 102 forms), a mom icon 504 and a user device icon 506 indicating to the second user 104 that it may be second user's turn to communicate to the first user 102 by using the reciprocal communication system 200. The transition screen 500 may additionally include a timer 508, indicating a time limit during which the second user 104 may need to respond to the sentence 502.

When the second user 104 may be ready to respond to the sentence 502, the second user 104 may click on an enter button 510 on the transition screen 500. Responsive to the second user 104 clicking the enter button 510, the user interface 206 may send an enter signal to the processor 204, indicating that the second user 104 may be ready to respond to the sentence 502.

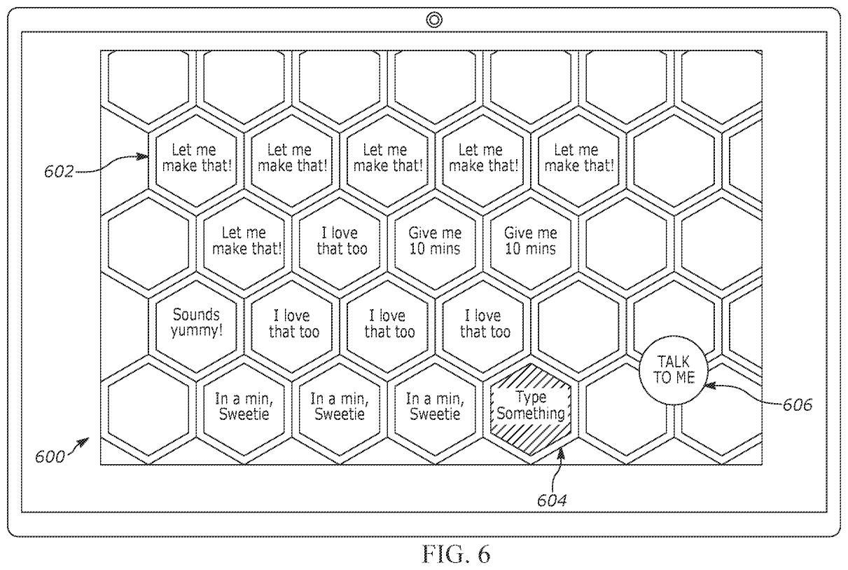

The processor 204 may display a second user input screen on the user interface 206, in response to receiving the enter signal from the user interface 206. FIG. 6 depicts an example snapshot of the reciprocal communication system 200 illustrating a second user/parent input screen 600 that may be displayed on the user interface 206 when the second user 104 clicks the enter button 510.

The second user input screen 600 may include a plurality of preset responses 602 and a virtual keyboard button 604. The second user 104 may customize the plurality of preset responses 602, and the processor 204 may store the customized preset responses in the user profile database 214. In this case, the processor 204 may first fetch the plurality of preset responses 602 from the user profile database 214, before the second user input screen 600 displays the plurality of preset responses 602.

The second user 104 may click on any preset response or the virtual keyboard button 604 to respond to the sentence 502. In some aspects, a virtual keyword (not shown) may overlay the second user input screen 600, when the second user 104 clicks on the virtual keyboard button 604. The second user 104 may use the virtual keyword to type a customized response to the sentence 502.

In some aspects, the second user 104 may click a “Talk to me” button 606 (or a similar submit button), when the second user 104 may be ready to submit the response. Responsive to the second user 104 clicking the “Talk to me” button 606, the user interface 206 may send a second user submission signal to the processor 204. The processor 204 may then cause the speaker 208 to output an audio corresponding to the response submitted by the second user 104. Further, the processor 204 may display a first user input screen (not shown), which may be used by the first user 102 to respond to the second user 104. In some aspects, the first user input screen may be similar to the snapshots shown in FIG. 3A, FIG. 3B, and FIG. 4.

The first user 102 may use any primary graphic, secondary graphic, or tertiary graphic (as described above) to respond to the second user 104. Further, the first user 102 may use a plurality of short responses 416, as shown in FIG. 4, to respond to the second user 104.

By using the screens described above, the first user 102 and the second user 104 may engage in reciprocal communication in an iterative manner on the reciprocal communication system 200. The processor 204 may track the first user activity, for example, several times the first user 102 has clicked on the submission button 412, the time spent by the first user 102 for each submission, a number of words included in each sentence in a reciprocal communication session, and the like. The processor 204 may store the first user activity associated with the reciprocal communication session in the user activity database 222.

When the first user 102 (or the second user 104) wishes to end the reciprocal communication session, the first user 102 may click on an “I'm all done” button 418, as shown in FIG. 4.

In further aspects, the second user 104 may set threshold submission goals (or submission goals) for the first user 102, to encourage the first user 102 to engage in lengthier reciprocal communication with the second user 104. The second user 104 may further associate one or more rewards that may be provided to the first user 102, when the first user 102 achieves a submission goal. For example, the second user 104 may set a submission goal that the first user 102 may get a treat, a walk in the park or a tickle, when the first user submits three to five sentences in a single reciprocal communication session. Similarly, the second user 104 may set another submission goal that the first user 102 may get to view videos on the user device for a predetermined time (e.g., 15 minutes), when the first user submits more than five sentences in a single reciprocal communication session (or two to three sessions in a day). In further aspects, the second user 104 may set submission goals corresponding to a minimum number of words to be included in a single sentence, a maximum amount of time to frame a sentence, and/or the like.

In some aspects, the goals database 218 may store the submission goals set by the second user 104 for the first user 102, and the rewards database 220 may store a submission goal mapping with the associated one or more rewards.

In one or more aspects, the processor 204 may cause the user interface 206 to display the submission goals and the associated rewards, when the first user 102 forms one or more sentences on the reciprocal communication system 200. The submission goals and the associated rewards may act as a positive reinforcement for the first user 102 to prepare lengthier sentences (e.g., use more words in a sentence) and/or to submit a higher number of sentences.

In addition, the processor 204 may display the reward “won” by the first user 102, when the first user 102 clicks on the “I'm all done” button 418. Specifically, the processor 204 may fetch the submission goals and the associated rewards from the goals database 218 and the rewards database 220, when the first user 102 clicks on the “I'm all done” button 418. Further, the processor 204 may determine a count of submissions made by the first user 102 in the reciprocal communication session. For example, the processor 204 may determine a number of times the first user 102 has clicked on the submission button 412 by fetching the first user activity from the user activity database 222.

In response to determining the count of submissions, the processor 204 may determine whether the first user 102 has met/achieved a specific submission goal, from the submission goals stored in the goals database 218. If the first user 102 has achieved a submission goal, the processor 204 may determine the corresponding one or more rewards that may be given to the first user 102, based on the determined submission goal. For example, if the first user 102 submits four sentences in the reciprocal communication session, the processor 204 may determine that a treat or a walk in the park may be provided to the first user 102.

Responsive to determining the one or more rewards, the processor 204 may display graphics/icons corresponding to the rewards on the user interface 206. For example, the user interface 206 may display icons corresponding to a first user's favorite treat, a park, and a tickle. The first user 102 may select one or more icons, and the second user 104 may provide the corresponding reward(s) to the first user 102. In additional aspects, the processor 204 may cause the reciprocal communication system 200 to provide haptic feedback, when the first user 102 clicks on a reward icon. For example, the reciprocal communication system 200 may vibrate when the first user 102 clicks on the tickle icon. In this case, the second user 104 may use the reciprocal communication system 200 to tickle the first user 102, for example, when the reciprocal communication system 200 vibrates.

In additional aspects, the processor 204 may be configured to transmit, via the transmitter 210, the first user activity to an external server 224 by using a network 226. Specifically, the processor 204 may fetch the first user activity from the user activity database 222 when the first user 102 clicks on the “I'm all done” button 418, and may transmit the first user activity to the server 224 by using the network 226.

The network 226 may be, for example, a communication infrastructure in which the connected devices discussed in various embodiments of this disclosure may communicate. The network 226 may be and/or include the Internet, a private network, public network or other configuration that operates using any one or more known communication protocols such as, for example, transmission control protocol/Internet protocol (TCP/IP), Bluetooth BLE®, Wi-Fi based on the Institute of Electrical and Electronics Engineers (IEEE) standard 802.11, UWB, and cellular technologies such as Time Division Multiple Access (TDMA), Code Division Multiple Access (CDMA), High Speed Packet Access (HSPDA), Long-Term Evolution (LTE), Global System for Mobile Communications (GSM), and Fifth Generation (5G), to name a few examples.

In some aspects, the server 224 may be associated with a plurality of medical resources (e.g., doctors), and may be used to store first user activities (e.g., children's activities) of a plurality of reciprocal communication systems connected with the server 224 via the network 226. Further, the server 224 may store a mapping of each first user (e.g., child) with an associated medical resource. In one or more aspects, when the server 224 receives the first user activity from the processor 204, the server 224 may identify a medical resource associated with the first user 102 and may transmit the first user activity to the identified medical resource. Specifically, the server 224 may transmit the first user activity to a user device (e.g., a mobile phone, a laptop, and/or the like) associated with the identified medical resource by using the network 226.

The medical resource may determine child development (e.g., the first user development) from the received first user activity. In some aspects, the medical resource may additionally identify and recommend modifications to the submission goals and/or the associated rewards (set by the second user 104 for the first user 102), based on the first user activity. For example, if the medical resource determines that the child is developing well, the medical resource may recommend increasing the threshold for rewards in the submission goals. For example, the medical resource may recommend increasing the submission threshold to six submissions or more, for the reward associated with providing a favorite treat to the first user 102.

In some aspects, the medical resource may send the recommendation to the server 224, which may further transmit the recommendation to the receiver 202. In response to receiving the recommendation, the processor 204 may cause the user interface 206 to display the recommendations to the second user 104. The second user 104 may modify the submission goals and/or the associated rewards based on the recommendations and may store the modified submission goals and/or the rewards in the goals database 218 and the rewards database 220.

In yet another aspect, the server 224 may include a neural network model (not shown) that may analyze the first user activities of a plurality of first users (e.g., children) using their respective reciprocal communication systems, and provide recommendations for modifications to the submission goals and/or the rewards to the second user 104. For example, the neural network model may identify submission goals and/or rewards for those children that may be submitting a higher number of sentences than the first user 102 and may recommend the submission goals and/or rewards associated with such children to the second user 104. The second user 104 may view the recommended submission goals and/or rewards on the user interface 206 (as described above) and may modify the goals and/or the rewards for the first user 102 based on the recommendation.

In one or more aspects, the neural network model described above may be a trained or unsupervised neural network model that may analyze the information received from a plurality of reciprocal communication systems using machine learning and natural language processing, which may facilitate determination of goal/reward recommendations for the first user 102.

Examples of the neural network model may include, but are not limited to, a deep neural network (DNN), a convolutional neural network (CNN), a recurrent neural network (RNN), a CNN-recurrent neural network (CNN-RNN), R-CNN, Fast R-CNN, Faster R-CNN, an artificial neural network (ANN), a Long Short Term Memory (LSTM) network based RNN, CNN+ANN, LSTM+ANN, a gated recurrent unit (GRU)-based RNN, a fully connected neural network, a deep Bayesian neural network, a Generative Adversarial Network (GAN), and/or a combination of such networks. In some aspects, the neural network model may include numerical computation techniques using data flow graphs. In one or more aspects, the neural network model may be based on a hybrid architecture of multiple Deep Neural Networks (DNNs).

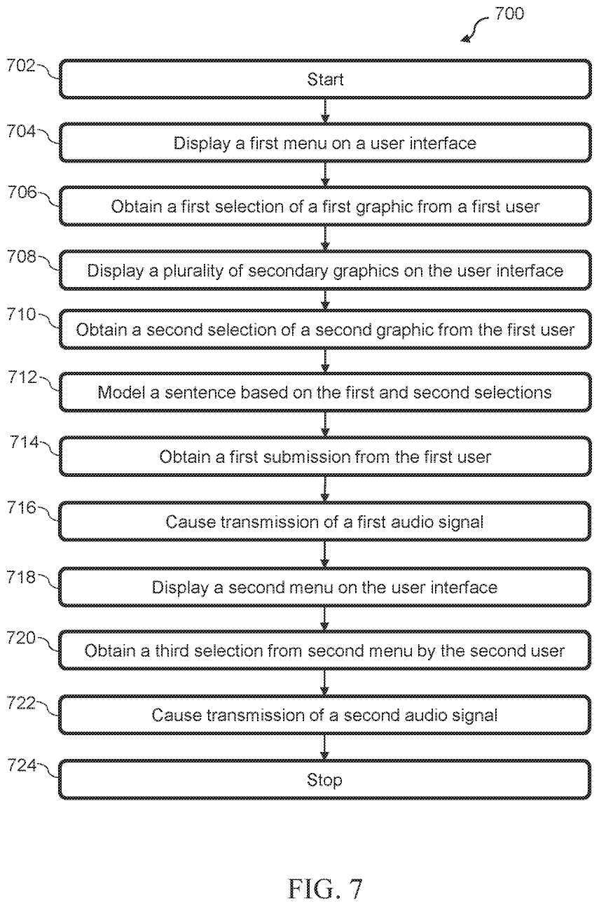

FIG. 7 depicts a flow diagram of an example reciprocal communication method 700 in accordance with the present disclosure. FIG. 7 may be described with continued reference to prior figures. The following process is exemplary and not confined to the steps described hereafter. Moreover, alternative embodiments may include more or less steps that are shown or described herein and may include these steps in a different order than the order described in the following example embodiments.

Referring to FIG. 7, at step 702, the method 700 may commence. At step 704, the method 700 may include displaying, by the processor 204, a first menu on the user interface 206. As described above, the first menu may include the plurality of primary graphics 302. Each primary graphic may be associated with a verbal cue and may correspond to a parent taxonomy category.

As described above, the processor 204 may display the first menu when the second user 104 accesses the reciprocal communication system 200 to initiate reciprocal communication with the first user 102. Similarly, the processor 204 may display the first menu when the first user 102 accesses the reciprocal communication system 200 to express his desire or need or to initiate reciprocal communication with the second user 104.

At step 706, the method 700 may include obtaining, by the processor 204, a first selection of a first graphic (e.g., the people icon 304), from the plurality of primary graphics, from the first user 102. At step 708, the method 700 may include displaying, by the processor 204, the plurality of secondary graphics 306 on the user interface 206, based on the first selection. As described above, the plurality of secondary graphics 306 may be associated with child taxonomy categories of a first graphic parent taxonomy category.

At step 710, the method 700 may include obtaining, by the processor 204, a second selection of a second graphic (e.g., the mom icon 308), from the plurality of secondary graphics 306, from the first user 102. At step 712, the method 70 may include modelling, by the processor 204, a sentence based on the first selection and the second selection. In some aspects, the modelled sentence is associated with the verbal cues that the first user 102 may want to communicate to the second user 104.

At step 714, the method 700 may include obtaining, by the processor 204, a first submission from the first user 102 to communicate the sentence with the second user 104. Responsive to obtaining the first submission, at step 716, the method 700 may include causing, by the processor 204, transmission of a first audio signal corresponding to the sentence to the speaker 208, based on the first submission. Responsive to receiving the first audio signal, the speaker 208 may output a first audio. At step 718, the method 700 may include displaying, by the processor 204, a second menu having a set of inputs (e.g., the plurality of preset responses 602 and the virtual keyboard button 604) on the user interface 206 for the second user 104 to communicate with the first user 102, in response to the transmission.

At step 720, the method 700 may include obtaining, by the processor 204, a third selection from the set of inputs, from the second user 104. At step 722, the method 700 may include causing, by the processor 204, transmission of a second audio signal based on the third selection to the speaker 208. Responsive to receiving the second audio signal, the speaker 208 may output a second audio.

At step 724, the method 700 may stop.

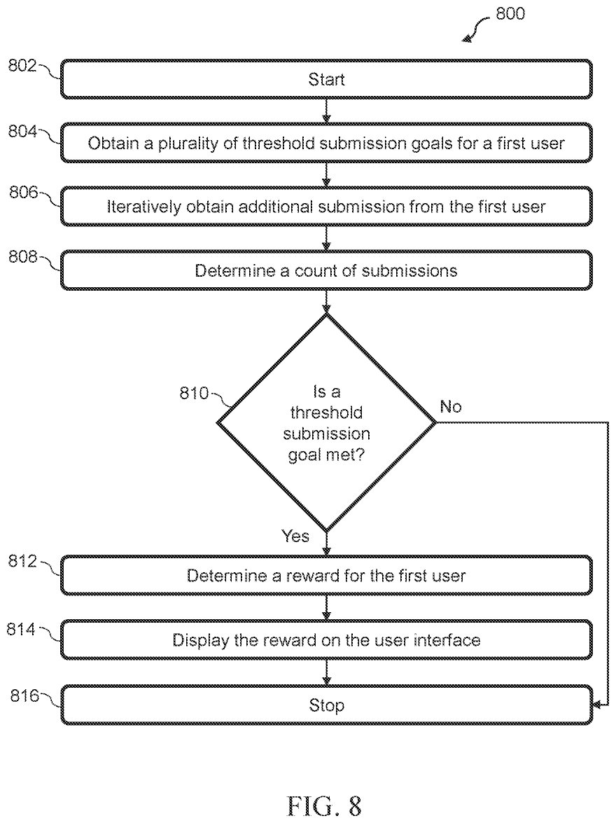

FIG. 8 depicts a flow diagram of an example reward display method 800 in accordance with the present disclosure. FIG. 8 may be described with continued reference to prior figures. The following process is exemplary and not confined to the steps described hereafter. Moreover, alternative embodiments may include more or less steps that are shown or described herein and may include these steps in a different order than the order described in the following example embodiments.

Referring to FIG. 8, at step 802, the method 800 may commence. At step 804, the method 800 may include obtaining, by the processor 204, a plurality of threshold submission goals (or communication goals) for the first user 102 to communicate with the second user 104 (or any other user). As described above, the second user 104 may set the plurality of threshold submission goals for the first user 102.

At step 806, the method 800 may include iteratively obtaining, by the processor 204, at least one additional submission (or one or more submissions) from the first user 102. At step 808, the method 800 may include determining, by the processor 204, a count or number of submissions made by the first user 102. For example, the processor 204 may count a number of times the first user 102 clicks on the submission button 412 in a single reciprocal communication session.

At step 810, the method 800 may include determining, by the processor 204, whether the first user 102 has met/achieved a threshold submission goal, from the plurality of threshold submission goals, based on the count. If the first user 102 achieves a threshold submission goal, the method 800 moves to step 812. At step 812, the method 800 may include determining, by the processor 204, a reward for the first user 102 associated with the threshold submission goal that the first user 102 has achieved. At step 814, the method 800 may include displaying, by the processor 204, the reward on the user interface 206.

If the processor 204 determines at the step 810 that the first user 102 has not achieved any threshold submission goal, the method 800 moves to step 816, at which the method 800 stops.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method to facilitate reciprocal communication between a first user and a second user, the method comprising:
displaying, by a processor, a first menu having a plurality of primary graphics on a user interface, wherein the plurality of primary graphics is associated with a plurality of verbal cues, and wherein the plurality of primary graphics corresponds to parent taxonomy categories;
obtaining, by the processor, a first selection of a first graphic, from the plurality of primary graphics, from the first user;
displaying, by the processor, a plurality of secondary graphics on the user interface based on the first selection, wherein the plurality of secondary graphics corresponds to child taxonomy categories of a first graphic parent taxonomy category;
obtaining, by the processor, a second selection of a second graphic, from the plurality of secondary graphics, from the first user;
modelling, by the processor, a sentence based on the first selection and the second selection, wherein the sentence is associated with verbal cues that the first user wants to communicate;
obtaining, by the processor, a first submission from the first user to communicate the sentence with the second user;
causing, by the processor, transmission of a first audio signal to a speaker in response to the first submission, wherein the speaker is configured to output a first audio that corresponds to the sentence;
displaying, by the processor, a second menu having a set of inputs on the user interface for the second user to communicate with the first user, in response to a first audio signal transmission;
obtaining, by the processor, a third selection from the set of inputs by the second user; and
causing, by the processor, transmission of a second audio signal to the speaker in response to the third selection, wherein the speaker is further configured to output a second audio that corresponds to the third selection.

2. The method of claim 1, wherein the plurality of primary graphics comprises at least one of: people, “I want”, “I need”, “I feel”, food, drinks, daily routine, comfort, help, descriptors, and school.

3. The method of claim 1 further comprising causing, by the processor, transmission of a primary audio signal corresponding to the first graphic based on the first selection to the speaker, and a secondary audio signal corresponding to the second graphic based on the second selection to the speaker, wherein the speaker is further configured to output a primary audio and a secondary audio corresponding to the primary audio signal and the secondary audio signal.

4. The method of claim 1 further comprising obtaining, by the processor, the plurality of secondary graphics corresponding to the first selection.

5. The method of claim 1, wherein the set of inputs comprises a set of predetermined responses and a virtual keyboard to input a customized response.

6. The method of claim 1 further comprising:
obtaining, by the processor, a plurality of threshold submission goals for the first user to communicate with the second user;
iteratively obtaining, by the processor, at least one additional submission from the first user;
determining, by the processor, a count of the first submission and the at least one additional submission;
determining, by the processor, whether a threshold submission goal, from the plurality of threshold submission goals, is met based on the count;
determining, by the processor, a reward for the first user associated with the threshold submission goal based on a determination that the threshold submission goal is met; and
displaying, by the processor, the reward on the user interface.

7. The method of claim 6, wherein the reward comprises playing a game on a user device, a special treat, watching a video on the user device, or a user device haptic feedback.

8. The method of claim 1 further comprising causing, by the processor, transmission of the first submission to a server, wherein the server transmits the first submission to a medical resource associated with the first user.

9. A system to facilitate reciprocal communication between a first user and a second user, the system comprising:
a processor; and
a memory for storing executable instructions, the processor programmed to execute the instructions to:
display a first menu having a plurality of primary graphics on a user interface, wherein the plurality of primary graphics is associated with a plurality of verbal cues, and wherein the plurality of primary graphics corresponds to parent taxonomy categories;
obtain a first selection of a first graphic, from the plurality of primary graphics, from the first user;
display a plurality of secondary graphics on the user interface based on the first selection, wherein the plurality of secondary graphics corresponds to child taxonomy categories of a first graphic parent taxonomy category;
obtain a second selection of a second graphic, from the plurality of secondary graphics, from the first user;
model a sentence based on the first selection and the second selection, wherein the sentence is associated with verbal cues that the first user wants to communicate;
obtain a first submission from the first user to communicate the sentence with the second user;
cause transmission of a first audio signal to a speaker in response to the first submission, wherein the speaker is configured to output a first audio that corresponds to the sentence;
display a second menu having a set of inputs on the user interface for the second user to communicate with the first user, in response to a first audio signal transmission;
obtain a third selection from the set of inputs by the second user; and
cause transmission of a second audio signal to the speaker in response to the third selection, wherein the speaker is further configured to output a second audio that corresponds to the third selection.

10. A system of claim 9, wherein the processor is further configured to cause transmission of a primary audio signal corresponding to the first graphic based on the first selection to the speaker, and a secondary audio signal corresponding to the second graphic based on the second selection to the speaker, wherein the speaker is further configured to output a primary audio and a secondary audio corresponding to the primary audio signal and the secondary audio signal.

11. The system of claim 9, wherein the processor is further configured to obtain the plurality of secondary graphics corresponding to the first selection.

12. The system of claim 9, wherein the set of inputs comprises a set of predetermined responses and a virtual keyboard to input a customized response.

13. The system of claim 9, wherein the processor is further configured to:
obtain a plurality of threshold submission goals for the first user to communicate with the second user;
iteratively obtain at least one additional submission from the first user;
determine a count of the first submission and the at least one additional submission;
determine whether a threshold submission goal, from the plurality of threshold submission goals, is met based on the count;
determine a reward for the first user associated with the threshold submission goal based on a determination that the threshold submission goal is met; and
display the reward on the user interface.

14. The system of claim 13, wherein the reward comprises playing a game on a user device, a special treat, watching a video on the user device, and a user device haptic feedback.

15. The system of claim 9, wherein the processor is further configured to cause transmission of the first submission to a server, and wherein the server transmits the first submission to a medical resource associated with the first user.

16. A non-transitory computer-readable storage medium in a distributed computing system, the non-transitory computer-readable storage medium having instructions stored thereupon which, when executed by a processor, cause the processor to:
display a first menu having a plurality of primary graphics on a user interface, wherein the plurality of primary graphics is associated with a plurality of verbal cues, and wherein the plurality of primary graphics corresponds to parent taxonomy categories;
obtain a first selection of a first graphic, from the plurality of primary graphics, from a first user;
display a plurality of secondary graphics on the user interface based on the first selection, wherein the plurality of secondary graphics corresponds to child taxonomy categories of a first graphic parent taxonomy category;
obtain a second selection of a second graphic, from the plurality of secondary graphics, from the first user;
model a sentence based on the first selection and the second selection, wherein the sentence is associated with verbal cues that the first user wants to communicate;
obtain a first submission from the first user to communicate the sentence with a second user;
cause transmission of a first audio signal to a speaker in response to the first submission, wherein the speaker is configured to output a first audio that corresponds to the sentence;
display a second menu having a set of inputs on the user interface for the second user to communicate with the first user, in response to a first audio signal transmission;
obtain a third selection from the set of inputs by the second user; and
cause transmission of a second audio signal to the speaker in response to the third selection, wherein the speaker is further configured to output a second audio that corresponds to the third selection.

17. A non-transitory computer-readable storage medium of claim 16, having further instructions stored thereupon to cause transmission of a primary audio signal corresponding to the first graphic based on the first selection to the speaker, and a secondary audio signal corresponding to the second graphic based on the second selection to the speaker, wherein the speaker is further configured to output a primary audio and a secondary audio corresponding to the primary audio signal and the secondary audio signal.

18. A non-transitory computer-readable storage medium of claim 16, wherein the set of inputs comprises a set of predetermined responses and a virtual keyboard to input a customized response.

19. A non-transitory computer-readable storage medium of claim 16, having further instructions stored thereupon to:
obtain a plurality of threshold submission goals for the first user to communicate with the second user;
iteratively obtain at least one additional submission from the first user;
determine a count of the first submission and the at least one additional submission;
determine whether a threshold submission goal, from the plurality of threshold submission goals, is has met based on the count;
determine a reward for the first user associated with the threshold submission goal based on a determination that the threshold submission goal is met; and
display the reward on the user interface.

20. A non-transitory computer-readable storage medium of claim 19, wherein the reward comprises playing a game on a user device, a special treat, watching a video on the user device, and a user device haptic feedback.
